(19) United States
(12) Patent Application Publication
(10) Pub. No.: US 2009/0122365 A1
(43) Pub. Date: May 14, 2009

(54) DOUBLE-SIDE IMAGE READING DEVICE AND IMAGE FORMING APPARATUS CAPABLE OF EXECUTING READING OF ORIGINAL WITH HIGH THROUGHPUT WHILE TAKING IMAGE QUALITY OF READ ORIGINAL INTO ACCOUNT

(75) Inventors: Takashi NODA, Okazaki-shi (JP); Yasuhide Kokura, Toyohashi-shi (JP); Yasuomi Mitsui, Toyokawa-shi (JP); Yoshihiko Hatta, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/248,674

(22) Filed: Oct. 9, 2008

(30) Foreign Application Priority Data
Nov. 13, 2007 (JP) 2007-294585

(51) Int. Cl. H04N 1/04

(52) U.S. Cl. 358/498

(57) ABSTRACT

Whether it is a double-side original mode is determined. When it is the double-side original mode, whether it is two-in-one printing mode is determined. When it is two-in-one printing mode, sequential reading mode is set. When it is not two-in-one printing mode, whether it is double-side printing and two-point stapling mode is determined. When it is double-side printing and two-point stapling mode, sequential reading mode is set. When it is not double-side printing and two-point stapling mode, whether it is booklet mode is determined. When it is booklet mode, alternate reading mode is set. When it is not booklet mode, concurrent reading mode is set.

This application is based on Japanese Patent Application No. 2007-294585 filed with the Japan Patent Office on Nov. 13, 2007, the entire content of which is hereby incorporated by reference.

### BACKGROUND OF THE INVENTION

1. Field of the Invention

The present invention relates to a double-side image reading device and an image forming apparatus, and particularly to a double-side image reading device and an image forming apparatus capable of reading both faces of an original.

2. Description of the Related Art

There is known an image reading device of a sheet through type in which an image on an original is read while an automatic document feeder (hereinafter, also referred to as “ADF”) conveys the original.

In recent years, also known is an image reading device having two image sensors for reading an original, whereas the two image sensors read both faces of an original while the ADF conveys the original, namely executes concurrent reading. This enables high speed reading of both faces of an original.

On the other hand, for achieving miniaturization of an image reading device, it is sometimes a case where a CIS (Contact Image Sensor) is used for reading of the back face of the original, while a CCD (Charge Coupled Device) sensor is used for reading the front face of the original.

However, a CIS is more likely to cause color drift than a CCD sensor when scanning is executed at high speed, and is difficult to be brought into focus because of its small focal depth when an original is not in close contact with a document platen.

Therefore, it is found that difference in image quality occurs owing to different image sensors when concurrent reading is executed by using the CIS and the CCD sensor. In Japanese Laid-Open Patent Publication No. 2004-015299 and Japanese Laid-Open Patent Publication No. 2007-074500, there is proposed, for example, a method of reading (scanning) images on front and back faces of an original using either one of the image sensors, for example, using only the CCD sensor, while reversing the face of the original in the conveyance path of the ADF when the original has color image or when emphasis is put on image quality, because difference in image quality clearly appears in reading of color image.

Further, in Japanese Laid-Open Patent Publication No. 2005-012442, there is disclosed a method that allows selection of the reading mode depending on the need of user whether priority is given to image quality or speed. To be more specific, there is proposed a reading (scanning) method, wherein when image quality priority mode in which priority is given to image quality is selected, face of the original is inverted in the conveyance path of the ADF, and images on the front face and the back face are read by using one of the image sensors, e.g., using only the CCD sensor, whereas when the speed priority mode in which priority is given to speed is selected, both faces are read (scanned) concurrently using both of the CIS and the CCD sensor.

Further, in Japanese Laid-Open Patent Publication No. 2007-082033, there is proposed a method of eliminating difference in image quality occurring due to difference between image sensors, by providing an additional CIS and reading front and back faces of an original with the use of two CISs to eliminate the difference in image quality that occurs due to difference between image sensors when concurrent reading is executed using the CIS and the CCD sensor.

Now description will be given for a case where one-point stapling is executed as an output. The expression “executing one-point stapling as an output form” refers to executing stapling process for a plurality of printing sheets, for example, at left upper end of a plurality of printing sheets.

FIG. 15 is a view showing one example of two double-side originals.

In FIGS. 15(a) to (c), views of a first double-side original are shown. In FIGS. 15(d) to (f), views of a second double-side original are shown.

With reference to FIG. 15(a), here is shown a graphic of right-pointing arrow on the front face of the first double-side original. Also shown is a graphic of left-pointing arrow bordered by dotted lines drawn on the back face, viewed from front face.

In FIG. 15(b), a graphic of right-pointing arrow drawn on the front face of the first double-side original is shown.

In FIG. 15(c), a graphic of right-pointing arrow drawn on the back face of the first double-side original is shown.

With reference to FIG. 15(d), here is shown a graphic of up-pointing arrow drawn on the front face of the second double-side original. Also shown is a graphic of down-pointing arrow bordered by dotted lines drawn on the back face, viewed from front face.

In FIG. 15(e), a graphic of up-pointing arrow drawn on the front face of the second double-side original is shown.

In FIG. 15(f), a graphic of down-pointing arrow drawn on the back face of the second double-side original is shown.

FIG. 16 is an explanatory view for a case where two double-side originals are sequentially read by the same image sensor, and double-side printing and one-point stapling are executed. Here, description will be given for a case where for two double-side originals, the face of the original is reversed in the conveyance path of the ADF, and images on front and back faces are read by using either one of the image sensors, for example, only by a CCD sensor, and double-side printing is executed.

Referring to FIG. 16(a), here is shown front face of double-side printed first printing sheet. To be more specific, as one example, there is shown a case where the front face of the first double-side original is read using a CCD sensor, and the read graphic is printed on the front face of first printing sheet. Also shown is a graphic of left-pointing arrow bordered by dotted lines drawn on the back face, viewed from front face of first sheet, and graphics of arrows bordered by dotted lines on the front face and back face of second sheet.

With reference to FIG. 16(b), here is shown a case where printing sheets having subjected to stapling process are bent at the left upper end, and reading of the back face of the first double-side original is executed using a CCD, and the read graphic is printed on the back face of first printing sheet.

With reference to FIG. 16(c), here is shown a case where printing sheets having subjected to stapling process are bent at the left upper end, and reading of the front face of the second double-side original is executed using a CCD sensor, and the read graphic is printed on the front face of second printing sheet.

With reference to FIG. 16(d), here is shown a case where printing sheets having subjected to stapling process are bent at the left upper end, and reading of the back face of the second double-side original is executed using a CCD, and the read graphic is printed on the back face of second printing sheet.

Here, when stapling process is executed on a plurality of printing sheets, concretely, one-point stapling is executed, a user will view back face of first sheet, front face of second sheet and back face of second sheet while bending the sheets one by one, Therefore, the user will not view back face of first sheet and front face of second sheet at once. In other words, the user would not be conscious of difference in image quality even if there is a difference in image quality in a double-side original.

However, in a case where an ADF as described in the above Documents 1 to 3 which are prior arts is used, when the original bears color image, or a user selects giving priority on image quality, the face of the original is reversed within the conveyance path of the ADF and images on the front and back faces of the original are read using one of the image sensors, for example, only by a CCD sensor, and both faces are read by the same sensor regardless of a case where the output form is to execute one-point stapling of a plurality of printing sheets as described above. Therefore, processing efficiency is deteriorated.

When an ADF described in Document 4 is used, it is expected that processing efficiency will not be deteriorated because an original can be read concurrently with the use of two CISs, however, the size of the ADF main unit may become large because a CIS is newly provided in addition to one CCD sensor and CIS. Furthermore, additional provision of CIS will cause the problem of rise in cost.

On the other hand, when the following output form is selected in a case of printing a double-side original, a user can recognize the difference in image quality.

FIG. 17 is an explanatory view of a case where a double-side original is two-in-one (2 in 1) copied as an output form. The expression “a two-in-one copying of double-side original” means reading images on the front face and the back face of the double-side original individually, and printing the images into one printing sheet while size of images on the front faces and back faces of two originals are reduced.

Since FIGS. 17(a) to (c) are the same with the graphics shown in FIGS. 15(a) to (c), detailed description thereof will not be repeated.

With reference to FIG. 17(d), here is shown a case where concurrent reading of a double-side original is executed by using different image sensors (CCD sensor and CIS), and two-in-one copied. Graphics of two printed arrows have different image qualities.

In this manner, images on the front face and back face are read by different image sensors and printed on one printing sheet, so that a user will view an image on the front face and an image on the back face having different image qualities at once. Therefore, the user will be conscious of the difference in image quality when two-in-one copy is executed as an output form.

FIG. 18 is an explanatory view of a case where as an output form, two double-side originals are concurrently read by using different image sensors, and double-side printed, followed by execution of two-point stapling. Here, the expression “executing two-point stapling” means executing stapling process for the plurality of printing sheets, for example, at two points in left end of a plurality of printing sheets. Concretely, description will be made for a case where double-side printing is conducted and two-point stapling is executed for the two double-side originals shown in FIG. 15.

With reference to FIG. 18(a), here is shown a front face of double-side printed first printing sheet. Concretely, as one example, shown is a case where reading of the front face of the first double-side original is executed using a CCD sensor, and the read graphic is printed on the front face of first printing sheet. Also shown are a graphic of left-pointing arrow bordered by dotted lines drawn on the back face, viewed from front face of first sheet, and graphics of arrows bordered by dotted lines on the front face and back face of second sheet. As for the front face of the first original and the front face of the second original of the double-side originals, graphics read by the CCD sensor are printed, while as for the back face of the first original and the back face of the second original of the double-side originals, graphics read by using the CIS are printed.

With reference to FIG. 18(b), a case where left end of printing sheet having subjected to stapling process is bent will be described. Concretely, in the left part, there is shown a case where reading of the back face of the first double-side original is executed by using a CIS, and the read graphic is printed on the back face of first printing sheet. In the right part, there is shown a case where reading of the front face of the second double-side original is executed using a CCD sensor, and the read graphic is printed on the front face of second printing sheet.

With reference to FIG. 18(c), here is shown a back face of double-side printed second printing sheet. Concretely, as one example, a case where reading of the back face of the second double-side original is executed using a CIS, and the read graphic is printed on the back face of second printing sheet is shown.

Referring again to FIG. 18(b), in the present example, the left part shows the back face of the first double-side original read by a CIS and printed on printing sheet, while the right part shows the front face of the second double-side original read by a CCD sensor and printed on printing sheet. Therefore, a user can view the image on the back face of the first original on the left side, and the image on the front face of the second original on the right side at once, and hence would be conscious of difference in image quality when double-side printing and two-point stapling are executed as an output form.

FIG. 19 is an explanatory view of a case where the two double-side originals are concurrently read by using different image sensors, and booklet-copied as an output form. The term booklet copy refers to executing printing process of a plurality of pages on a single printing sheet so that the output result forms a booklet.

To be more specific, description will be made for a case where booklet copy is executed for the two double-side originals shown in FIG. 15. Images on the front face and the back face of the first original are referred to as Page 1, and Page 2, respectively. Images on the front face and the back face of the second original are referred to as Page 3, and Page 4, respectively.

When a document consisting of a total of four pages is booklet copied, two-in-one copy is executed for the originals of Page 1 and Page 4 on the front face of printing sheet so that a booklet is formed when the printing sheet is bent in the center part. Further, on the back face of printing sheet, two-in-one copy is executed for the originals of Page 2 and Page 3.

With reference to FIG. 19(a), here is shown a case where the printing sheet is bent in the center part as described above, wherein as Page 1, the image on the front face of the first double-side original is read and printed on the right side of the front face of the printing sheet by the two-in-one copy as described above.

With reference to FIG. 19(b), here is shown a condition where the printing sheet is spread from a condition of FIG. 19(a), and as Page 2 and Page 3, the image on the back face of the first double-side original and the image on the front face of the second double-side original are read, and printed on the left side and the right side of the back face of the printing sheet by the aforementioned two-in-one copy. In the present example, the left part shows a case where reading of the back face of the first double-side original is executed using a CIS, and the read graphic is printed on the back face of the printing sheet. The right part shows a case where reading of the front face of the second double-side original is executed using a CCD sensor, and the read graphic is printed on the back face of the printing sheet.

With reference to FIG. 19(c), here is shown a condition where the printing sheet is bent in the center part from a condition of FIG. 19(b), and as Page 4, there is shown a case where the image on the back face of the second double-side original is read by using a CIS, and is printed on the left side of the front face of the printing sheet by two-in-one copy as described above.

Referring again to FIG. 19(b), in the present example, the left part shows a back face of the first double-side original read by a CIS and printed on the printing sheet, while the right part shows a front face of the second double-side original read by a CCD sensor and printed on the printing sheet. Therefore, a user can view the image on the back face of first sheet as Page 2 on the left side, and the image on the front face of the second original as Page 3 on the right side at once, and hence would be conscious of difference in image quality when booklet copy is executed as an output form.

On the other hand, FIG. 20 is an explanatory view of a case where as an output form, the two double-side originals are sequentially read by using the same image sensor, and booklet copied. Here is shown a case where the front face and the back face of the double-side original are read by using the same image sensor, for example, by a CCD sensor, and booklet copied.

With reference to FIG. 20(a), here is shown a view of a case where the printing sheet is bent in the center part as described above, and a case where the image on the front face of the first double-side original is read as Page 1, and printed on the right side of the front face of the printing sheet by two-in-one copy as described above.

With reference to FIG. 20(b), here is shown a condition where the printing sheet is spread from a condition of FIG. 20(a), and as Page 2 and Page 3, the image on the back face of the first double-side original and the image on the front face of the second double-side original are read, and printed on the left side and the right side of the back face of the printing sheet, respectively, by two-in-one copy as described above.

With reference to FIG. 20(c), here is shown a view of a case where the printing sheet is bent in the center part from a condition of FIG. 20(b), and as Page 4, the image on the back face of the second double-side original is read and printed on the left side of the front face of the printing sheet by two-in-one copy as described above.

Here, FIGS. 20(a) to (c) show a case where the front faces and the back faces of the first and second double-side originals are read by the same image sensor, for example, by using a CCD sensor, and printed on printing sheet. Therefore, in this case, a user is not conscious of difference in image quality, however, the processing efficiency is deteriorated as described above because the face of the original is reversed in the conveyance path of ADF, and images on the front and back faces of the original are read using one of the image sensors, for example, using only a CCD sensor, and thus both faces are read by the same sensor.

Therefore, it is desired that reading of the original can be executed at high processing efficiency without causing rise in the cost, while taking output form executed by a user into account.

### SUMMARY OF THE INVENTION

The present invention was devised for solving the aforementioned problem, and aims at providing a double-side image reading device and an image forming apparatus capable of executing reading of an original at high processing efficiency according to output form executed by a user while taking image quality of read the original into account.

A double-side image reading device according to one aspect of the invention includes: a conveying section that includes a conveyance path for conveying a fed original; a first reading section that reads an image on one face of the original from one side of the conveyance path; a second reading section that reads an image on one face of the original from an opposite side to the first reading section with the conveyance path interposed therebetween; and a reading controlling section that controls the conveying section, the first and second reading sections for executing reading of a double-side original, wherein the reading controlling section responds to a setting designation of an output form for outputting the image of the double-side original to execute reading of the double-side original in one of a first and second double-side reading modes, the first double-side reading mode which allows reading of images on front and back faces of the double-side original by reading an image on one face of the double-side original using only one of the first and second reading sections and then reading an image on another face by using only one of the first and second reading sections by reversing and conveying the original, and the second double-side reading mode which allows reading of the images on the front and back faces of the double-side original using the first and second reading sections during a single conveyance.

Preferably, the reading controlling section designates execution of reading of the double-side original in the first double-side reading mode when the setting instruction of the output form for outputting the images on the double-side original is a mode for outputting the images on the front and back faces of at least one double-side original onto one face, and designates execution of reading of the double-side original in the second double-side reading mode in other cases.

Preferably, the reading controlling section designates execution of reading of the double-side original in the first double-side reading mode when the setting designation of the output form for outputting images on the double-side original is a mode for outputting the images on front and back faces of a plurality of double-side originals onto front and back faces of a plurality of printing sheets respectively and executing a stapling process in a plurality of points is designated, while the reading controlling section designates execution of reading of the double-side original in the second double-side reading mode in other cases.

Preferably, the reading controlling section designates execution of reading of the double-side original in the second double-side reading mode when the setting designation of the output form for outputting the images on the double-side original is a mode for outputting images on front and back faces of a plurality of double-side originals onto front and back faces of a plurality of printing sheets respectively and printing a booklet in which one printing sheet includes a plurality of pages is designated, while the reading controlling section designates execution of reading of images on front and back faces of a next double-side original in a reversed condition, compared to a case of reading images on front and back faces of a previous double-side original, in reading the images on the front and back faces of the plurality of double-side originals.

An image forming apparatus according to another aspect of the present invention includes the double-side image reading device, an output form setting section that sets an output form for outputting images on the double-side original, and an image forming section that forms an image read by the double-side image reading device.

Preferably, the image forming apparatus further includes a staple processing section that executes a stapling process in response to a designation on a plurality of printing sheets printed in the image forming section.

The double-side image reading device and the image forming apparatus of the present invention execute reading of the double-side original in either one of the first double-side reading mode and the second double-side reading mode based on the setting instruction of output form for outputting images on the double-side original. As for the output form, it is possible to execute reading of the original at high processing efficiency while taking image quality of read the original into account, by instructing the first double-side reading mode in the output form where difference in image quality is conscious, and by instructing the second double-side reading mode in the output form where difference in image quality is unconscious.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a section view showing an outline of an image forming apparatus including a double-side image reading device according to an embodiment of the present invention.

FIG. 2 is a schematic block diagram showing an internal control configuration of an MFP (Multi Function Peripheral).

FIG. 3 is a plan view showing a makeup of a panel in which a display section and an operation key group are arranged.

FIG. 4 is a view showing display contents in the display of display section when “one-side/double-side” setting button is pressed down.

FIG. 5 is a view showing display contents in the display of display section when a “combine/original” setting button is pressed down.

FIG. 6 is a view showing display contents in the display of display section when “application” setting button is pressed down.

FIG. 7 is a view showing display contents in the display of display section when “finishing” button is pressed down,

FIG. 8 is a schematic block diagram showing outlines of functions of the first and the second image processing sections.

FIG. 9 is a view showing a control flow for determining a reading mode of the double-side original according to an embodiment of the present invention.

FIG. 10 is a view showing a flow for controlling conveyance of the original according to the reading mode, according to an embodiment of the present invention.

FIG. 11 is a view showing a case where two double-side originals are read concurrently by using different image sensors, double-side printed, and one-point stapled.

FIG. 12 is a view showing a case where a double-side original is two-in-one copied in a sequential reading mode.

FIG. 13 is a view showing a case where double-side originals are double-side printed in a sequential reading mode and two-point stapled.

FIG. 14 is a view showing a case where double-side originals are booklet copied in an alternate reading mode.

FIG. 15 is a view showing one example of two double-side originals.

FIG. 16 is a view showing a case where two double-side originals are read sequentially by means of the same image sensor, and double-side printed, and then one-point stapling is executed.

FIG. 17 is a view showing a case where as an output form, double-side originals are two-in-one copied.

FIG. 18 is a view showing a case where as an output form, two double-side originals are concurrently read by using different image sensors, and double-side printed, and then two-point stapling is executed.

FIG. 19 is a view showing a case where as an output form, two double-side originals are concurrently read using different image sensors, and booklet copied.

FIG. 20 is a view showing a case where as an output form, two double-side originals are read sequentially using the same image sensor, and booklet copied.

### DESCRIPTION OF THE PREFERRED EMBODIMENTS

In the following, preferred embodiments of the present invention will be described with reference to attached drawings. In the following description, the identical part or element is denoted by the same reference numeral. These have identical name and function.

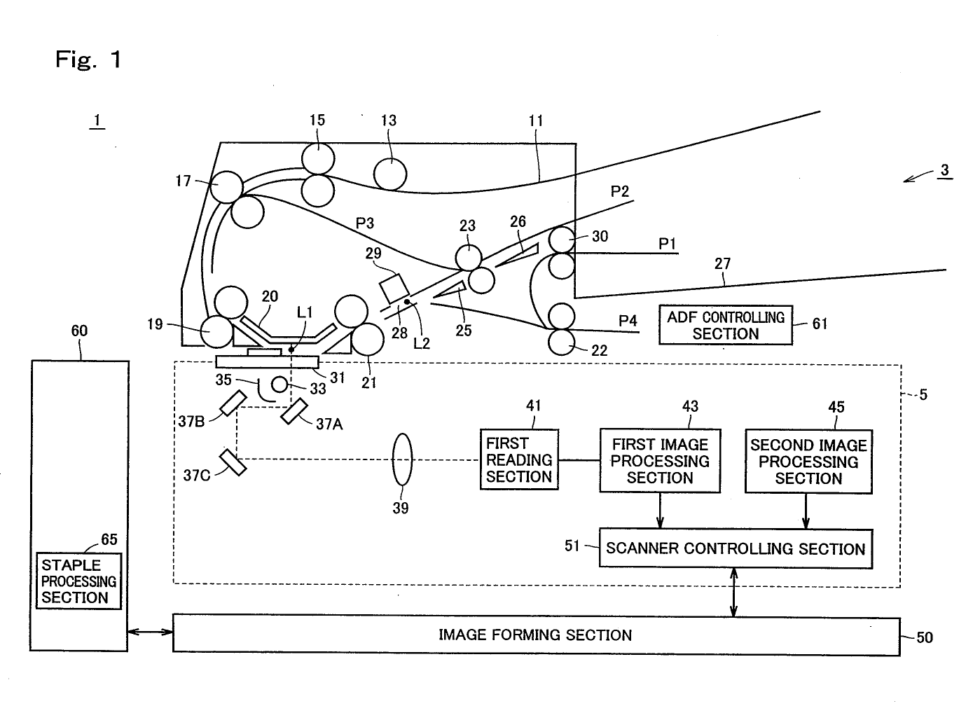

By using FIG. 1, outline of an image forming apparatus including a double-side image reading device according to an embodiment of the present invention will be described. Here, description will be made by taking an MFP 1 as a typical example of the image forming apparatus.

Referring to FIG. 1, MFP 1 of an embodiment of the present invention includes an automatic document feeder (ADF) 3, a scanner 5, an image forming section 50, and a post processing section 60.

ADF 3 includes a paper feed tray 11, a paper feed roller 13, a separation roller 15, a registration roller 17, a pre-reading roller 19, a conveyance guide member 20, an intermediate roller 21, a post-reading roller 23, a discharging roller 30, a reversing and discharging roller 22, a paper discharge tray 27, a discharge/reversion switching section 25, 26, a second reading section 29, and an ADF controlling section 61 for controlling the overall of ADF 3. ADF 3 and scanner 5 constitute a double-side image reading device.

Scanner 5 includes a platen glass 31 implemented by a transparent member, an optical source 33 for emitting light, a reflection member 35 for reflecting light from the optical source, a first reading section 41 in which three line sensors are arranged in the sub scanning direction, reflection mirrors 37A, 37B, 37C for reflecting reflected light from an original and guiding it to first reading section 41, a lens 39 for focusing light reflected at reflection mirror 37C onto first reading section 41, a first image processing section 43 for processing image data outputted by first reading section 41, a second image reading section 45 for processing image data outputted by second reading section 29, and a scanner controlling section 51 for controlling the overall of scanner 5.

Image forming section 50 executes image formation process of image data inputted from first and second image processing sections 43, 45 via scanner controlling section 51, and prints inputted image data on a printing sheet according to a predetermined printing mode.

Post processing section 60 executes post processing such as stapling process as is needed, and stapling process is executed in a staple processing section 65.

ADF controlling section 61 controls driving of motor which is a power source for rotating paper feed tray 11 and paper feed roller 13, separation roller 15, registration roller 17, pre-reading roller 19, intermediate roller 21, post-reading roller 23, reversing and discharging roller 22 and discharging roller 30. ADF controlling section 61 also executes control of discharge/reversion switching sections 25, 26 for executing discharge of paper or reversion of paper.

Paper feed roller 13 picks one original from the uppermost stage of a plurality of originals placed on paper feed tray 11, and conveys the original to separation roller 15, and separation roller 15 and registration roller 17 convey the original to pre-reading roller 19. Pre-reading roller 19 conveys the original to first reading position L1 of scanner 5 on platen glass 31 via conveyance guide member 20.

When the original having passed first reading position L1 reaches intermediate roller 21, it is conveyed to second reading position L2 by intermediate roller 21.

The original having passed intermediate roller 21 is guided to post-reading roller 23 through second reading position L2 of second reading section 29. At the time of discharging the original, the original is guided to discharging roller 30 by post-reading roller 23 and reversion switching section 26. The original having passed discharging roller 30 is discharged to paper discharge tray 27 from conveyance path P1 and stacked therein.

Alternatively, conveyance path may be switched according to switching of discharge/reversion switching section 25, 26, and the original may be first guided in the direction of conveyance path P2 from post-reading roller 23 and guided to registration roller 17 through conveyance path P3 again via post-reading roller 23. In this case, the original guided to registration roller 17 is guided in reverse condition of a condition in which it is guided previously to registration roller 17, and is again conveyable to first and second reading positions. Since the original conveyed to first and second reading positions is in reverse condition, the original may be first guided in the direction of conveyance path P4 from intermediate roller 21 according to switching of discharge/reversion switching sections 25, 26, and may be discharged to paper discharge tray 27 from conveyance path P1 by reversing and discharging roller 22 and discharging roller 30. With this arrangement, the reversed original returns to its original condition, and is guided to paper discharge tray 27 from discharging roller 30.

First reading section 41 includes a plurality of photoelectric conversion elements such as CCD (Charge Coupled Device) sensors arranged in the main scanning direction.

First reading section 41 optically reads an image formed on the original when the original conveyed by ADF 3 passes through first reading position L1, and outputs photo-electrically converted image data to first image processing section 43.

Second reading section 29 is implemented, for example, by a CIS (Contact Image Sensor) including a plurality of photoelectric conversion elements arranged in the main scanning direction which is substantially perpendicular to conveyance direction of the original.

Second reading section 29 faces with an opening 28 provided in the conveyance path of the original, and optically reads an image formed on the original passing through second reading position L2, and outputs photo-electrically converted image data to second image processing section 45.

Therefore, while ADF 3 conveys an original once, both sides of the original can be read by first reading section 41 and second reading section 29, respectively.

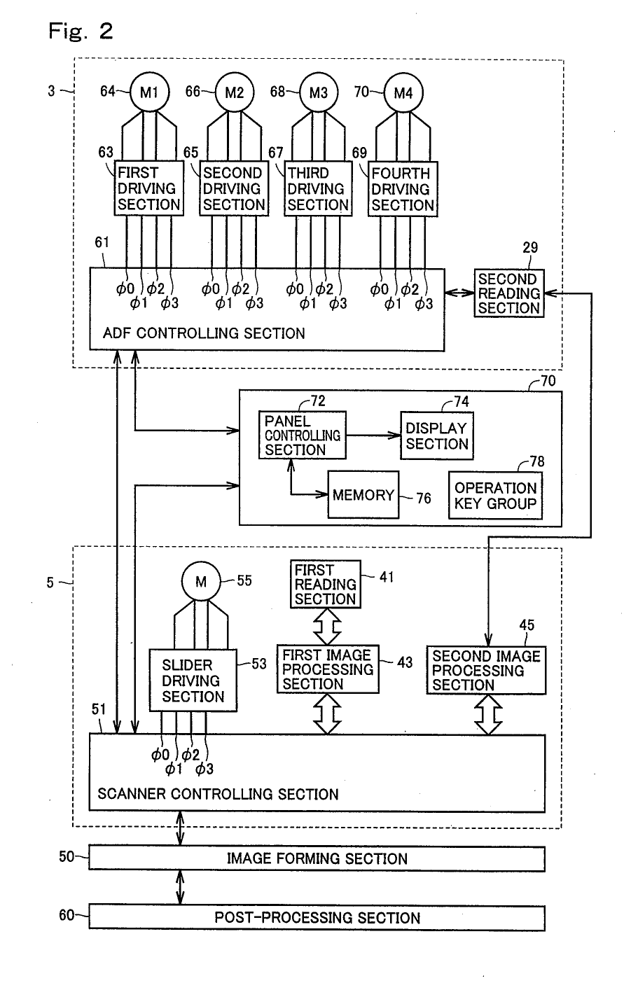

Internal control configuration of M 1 will be described using FIG. 2.

With reference to FIG. 2, MFP 1 includes ADF 3, scanner 5, image forming section 50, post processing section 60, and operation panel section 70.

Although not illustrated in FIG. 1, operation panel section 70 is attached to ADF 3 or image forming section 50, for example. Operation panel section 70 includes a panel controlling section 72, a display section 74, a memory 76, and an operation key group 78.

Panel controlling section 72 has a function of executing various processes and operation processes on each part within operation panel section 70. Panel controlling section 72 may be any of microprocessor, an FPGA (Field Programmable Gate Array) which is a programmable LSI (Large Scale Integration), an ASIC (Application Specific Integrated Circuit) which is an integrated circuit designed and produced for a specific application, and other circuits having operational function.

Display section 74 has a function of displaying various information to a user by way of s character, an image and the like. Display section 74 displays a character or an image based on a control instruction transmitted from panel controlling section 72. Display section 74 has a touch panel function which allows for a user to input information by directly touching the screen. Display section 74 may be any of LCD (Liquid Crystal Display), FED (Field Emission Display), organic EL display (Organic Electro Luminescence Display), and display devices of other image display system such as dot matrix.

Information inputted through operation key group 78 is transmitted to panel controlling section 72. Memory 76 is used as a work memory for temporarily storing data that is data-accessed by panel controlling section 72. Memory 76 may be formed by a RAM (Random Access Memory) capable of temporarily storing data.

ADF 3 includes ADF controlling section 61, first to fourth driving sections 63, 65, 67, 69 each connected to ADF controlling section 61, first to fourth pulse motors 64, 66, 68, 70 respectively connected to first to fourth driving sections 63, 65, 67, 69, and second reading section 29. Scanner 5 includes scanner controlling section 51, and slider driving section 53, first image processing section 43, and second image processing section 45 respectively connected to scanner controlling section 51, and first reading section 41 connected to first image processing section 43.

Scanner controlling section 51 and ADF controlling section 61 are connected in such a manner that they can communicate with each other. Second reading section 29 and second image processing section 45 are connected in such a manner that they can communicate with each other.

Scanner controlling section 51 and ADF controlling section 61 communicate with each other to receive/send various control information including size information on the original, operation mode, timing information for reading the original and so on.

First to fourth pulse motors 64, 66, 68, 70 are driven respectively by four excitation signals 40 to 43 outputted by first to fourth driving sections 63, 65, 67, 69.

Paper feed roller 13, separation roller 15, registration roller 17, pre-reading roller 19, intermediate roller 21, post-reading roller 23, reversing and discharging roller 22 and discharging roller 25 are separately driven by first to third driving sections 63, 65, 67. This makes an original pass through conveyance path by separately switching rotation speed and rotation direction depending on the timing at which the original is sent.

Concretely, first pulse motor 64 rotationally drives paper feed roller 13, separation roller 15 and registration roller 17. Second pulse motor 66 rotationally drives pre-reading roller 19 and intermediate roller 21. Third pulse motor 68 rotationally drives post-reading roller 23, reversing and discharging roller 22 and discharging roller 25.

First to third driving sections 63, 65, 67 determine conveyance condition such as speed at which the original is conveyed, depending on reading magnification and reading mode, and control driving of first to third pulse motors 64, 66, 68 so that the original is conveyed in the determined conveyance condition.

Fourth driving section 69 controls driving of fourth pulse motor 70. Fourth pulse motor 70 rotationally drives second reading section 29. When double-side image reading device 1 is set at a double-side reading mode for concurrently reading both sides of the original, fourth driving section 69 under the control of ADF controlling section 61 rotationally displaces second reading section 29 to a first position where second reading section 29 faces with second reading position L2. When image reading device 1 is set at one-side reading mode for reading one face of the original, fourth driving section 69 rotationally displaces second reading section 29 to a second position which is different to the direction in which second reading section 29 faces with second reading position L2.

Slider driving section 53 controls driving of slider motor 55. Slider motor 55 is a pulse motor, and displaces a movable slider unit to first reading position L1. Slider unit incorporates optical source 33, reflection member 35, and reflection mirror 37A.

To first image processing section 43, image data read from the original and outputted by first reading section 41 is inputted. First image processing section 43 makes a predetermined image process on inputted image data before outputting it to scanner controlling section 51. To second image processing section 45, image data read from the original and outputted by second reading section 29 is inputted. Second image processing section 45 makes a predetermined image process on inputted image data before outputting it to scanner controlling section 51.

Scanner controlling section 51 outputs inputted image data to image forming section 50. Alternatively, it may output to a computer, memory or the like connected thereto via external interface.

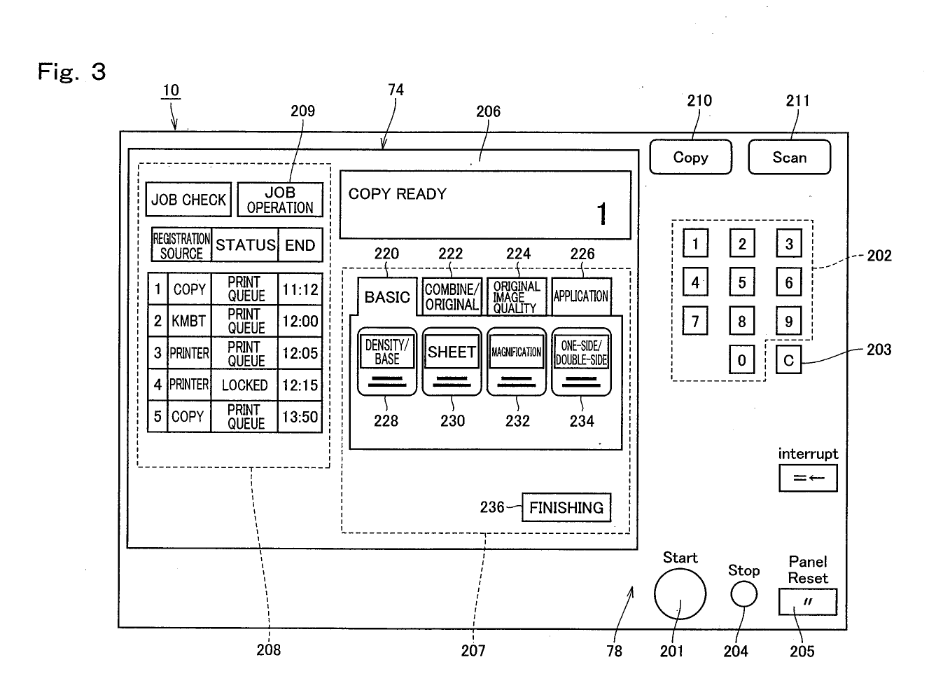

The configuration of panel 10 in which display section 74 and operation key group 78 are arranged will be described using FIG. 3.

In FIG. 3, a start key 201 is used for starting copy/scan operation and the like. A numeric keypad 202 is used for inputting numerical value such as copy number. A clear key 203 is used for clearing inputted numerical number, and discarding image data accumulated in image storing section.

A stop key 204 is used for instructing stop of copy/scan operation. A panel reset key 205 is used for discarding operation mode and job that are currently set.

A display that forms display section 74 displays various modes and the like, and a touch panel 206 is attached to the superficial face. This touch panel 206 enables a user to make various settings according to display contents in the display.

In a setting screen area 207 in touch panel 206, usually buttons for basic/application settings made in executing copy operation or scan operation are arranged. When each button is pressed down, a hierarchy screen for making advances settings is displayed.

Concretely, in the present example, a case where a “basic” setting button 220, a “combine/original” setting button 222, an “image quality of document” setting button 224, and an “application” setting button 226 are arranged is shown as an example. Also arranged is a “finishing” setting button 236 for setting sorting, and stapling and the like presses.

In the present example, a hierarchy screen in a condition where “basic” setting button 220 is pressed down is shown, and a “density/base” setting button 228 for adjusting density or base part of printing sheet, a “sheet” setting button 230 for setting sheet size, a “magnification” setting button 232 for setting printing magnification, and a “one-side/double-side” setting button 234 for setting the mode (one-side/double-side) of the original and the mode (one-side/double-side) of an output sheet (printing sheet) are shown as one example.

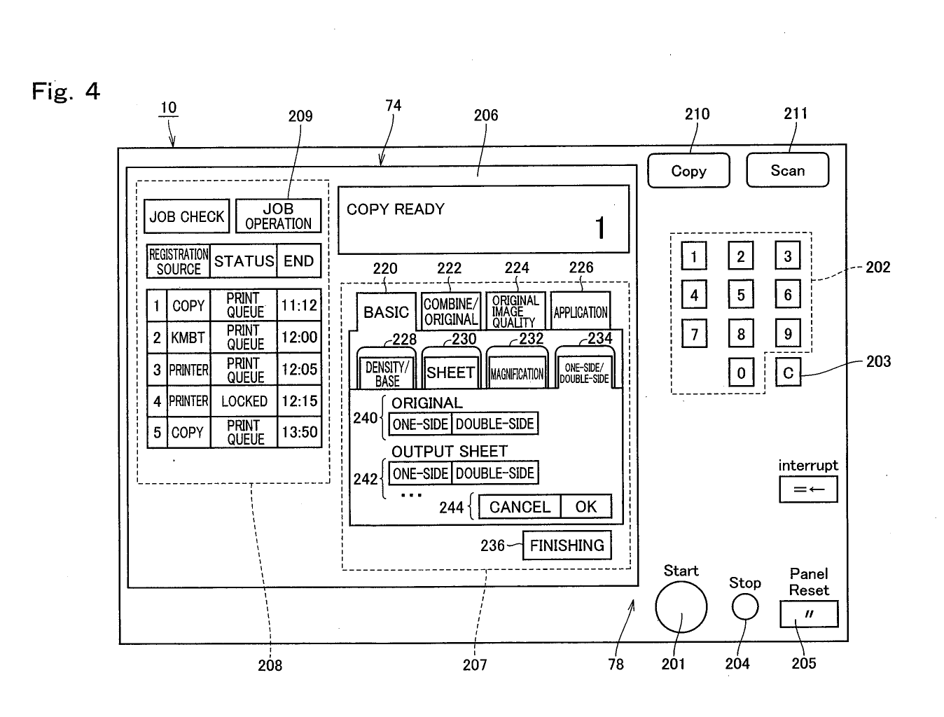

Display contents in the display of display section 74 in a case where “one-side/double-side” setting button 234 is pressed down will be described by using FIG. 4.

Referring to FIG. 4, there is shown a hierarchy screen in a condition where “one-side/double-side” setting button 234 is pressed down, in which a button area 240 for selecting whether the form of the original is one-side or double-side, a button area 242 for selecting one-side or double-side as a form of output sheet (printing sheet), and a button area 244 in which “cancel” button and “OK” button for canceling or selecting the contents selected in button areas 240, 242 are shown.

For example, by selecting the form of the original as double-side, selecting form of output sheet (printing sheet) as double-side, and pressing down “OK” button, it is possible to make a setting for copy operation for outputting the double-side original by double-side printing. By pressing down “cancel” button, the screen can be returned to the screen of FIG. 3 which is a previous screen.

Display contents in the display of display section 74 when “combine/original” setting button 222 is pressed down will be described using FIG. 5.

Referring to FIG. 5, there is shown a screen in a condition where “combine/original” setting button 222 is pressed down, including a button area 246 for allowing selection from two-in-one (2 in 1), four-in-one (4 in 1), and eight-in-one (8 in 1) as exemplary settings for combine, and a button area 248 in which a “cancel” button and a “OK” button are provided for canceling or setting the content selected in button area 246.

For example, by selecting “2 in 1” and pressing down the “OK” button, it is possible to set copy operation of two-in-one copy as an output form. By pressing down “cancel” button, the screen can be returned to the screen of FIG. 3 which is a previous screen.

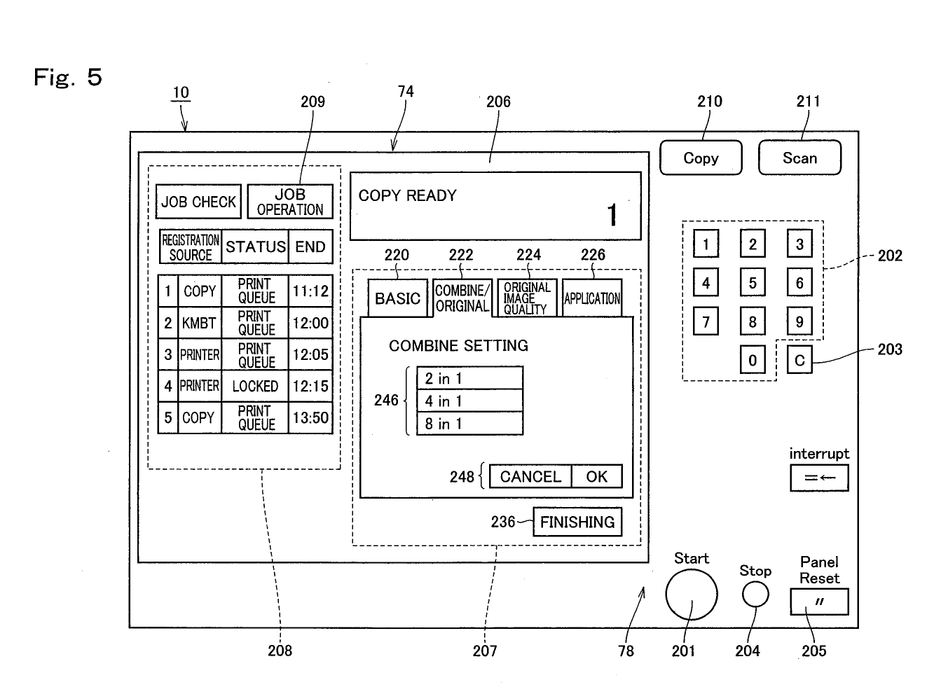

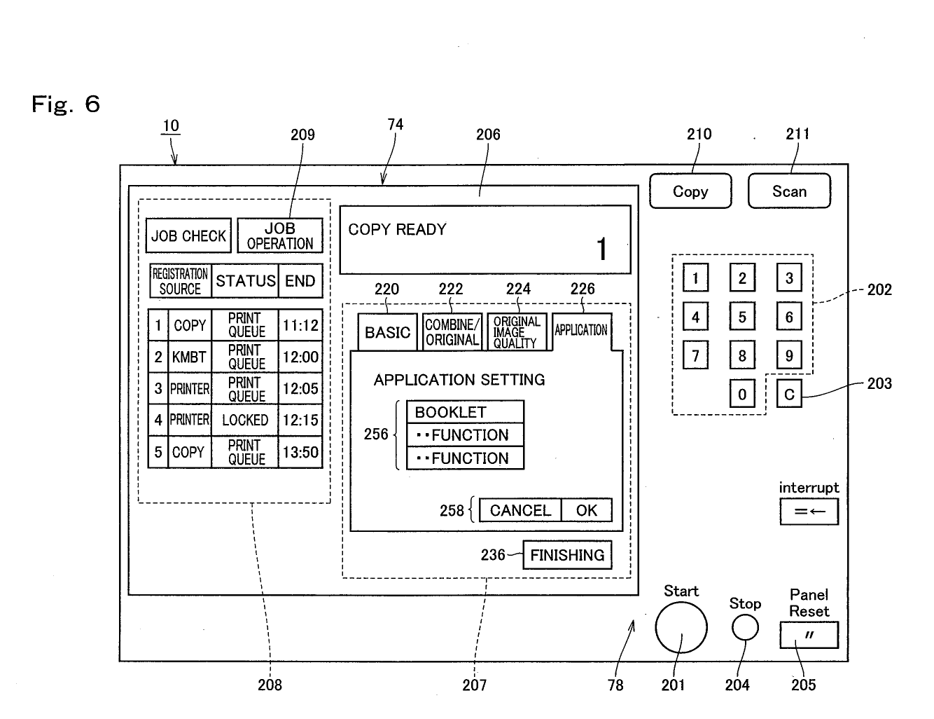

FIG. 6 is a view showing display contents in the display of display section 74 when “application” setting button 226 is pressed down.

Referring to FIG. 6, there is shown a screen in a condition where “application” setting button 226 is pressed down, including a button area 256 for selecting application function such as booklet copy, for example, and a button area 258 in which a “cancel” button and a “OK” button are provided for canceling or setting the content selected in button area 256.

For instance, by selecting booklet, and pressing down the “OK” button, it is possible to set booklet copy operation as an output form. By pressing down “cancel” button, the screen can be returned to the screen of FIG. 3 which is a previous screen.

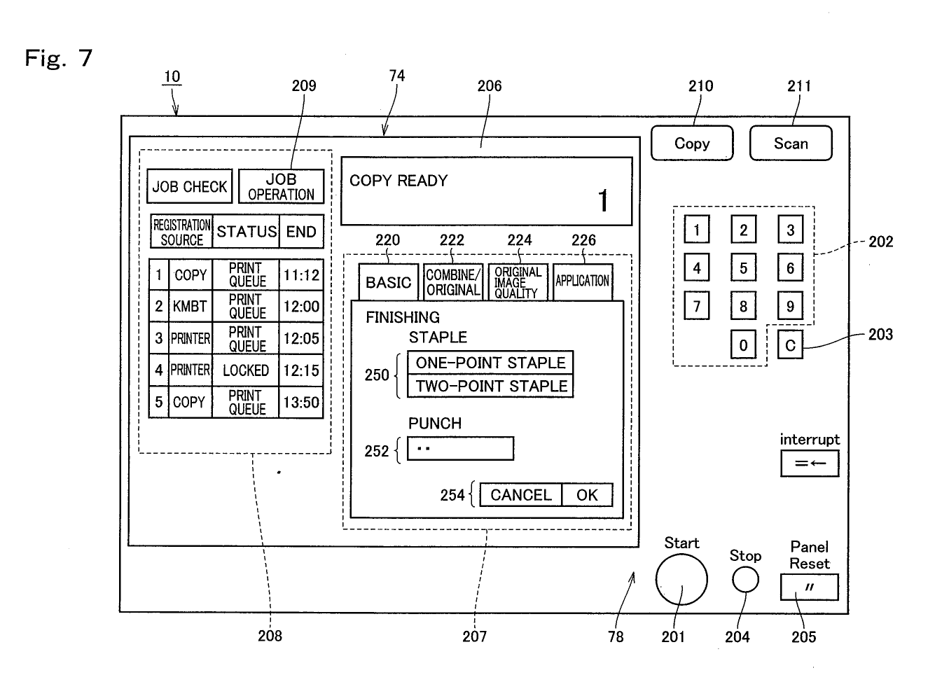

Display contents in the display of display section 74 when “finishing” button 236 is pressed down will be described by using FIG. 7.

Referring to FIG. 7, there is shown a screen in a condition where “finishing” button 236 is pressed down, including an button area 250 that allows selection between “one-point stapling” and “two-point stapling” as stapling process, a button area 252 for selecting punching process, as finishing settings, and a button area 254 in which a “cancel” button and a “OK” button are provided for canceling or setting the contents selected in button areas 250, 252.

For example, by selecting “one-point stapling” as stapling process and pressing down “OK” button, it is possible to set an operation of executing stapling process of one-point stapling on printing sheets as an output form. Likewise, by selecting “two-point stapling” as stapling process and pressing down “OK” button, it is possible to set an operation of executing stapling process of two-point stapling on printing sheets as an output form. By pressing down “cancel” button, the screen can be returned to the screen of FIG. 3 which is a previous screen.

Referring again to FIG. 3, in a job information screen area 208 of touch panel 206, job information populated into MFP 1 at that point of time is displayed. In the display, jobs are arranged in the order in which they are to be executed. For making an operation such as deletion or change on a specific job, a job operation button 209 is selected, and then a button of job number to be operated is pressed down. Through such procedure, a job operation screen is displayed, and operation on a specific job is enabled.

A copy key 210 and a scan key 211 are selection keys for selecting an operation mode of MFP 1 according to the copy or the scanner.

When copy key 210 is pressed down, MFP 1 is operable as a copying machine. In this condition, MFP 1 is disabled to execute scanner operation.

At this time, in setting screen area 207 of touch panel 206, copy mode display for making various settings for copy operation is provided. After completion of various settings, by setting an original and pressing down start key 201, copy operation is started. When scan key 211 is pressed down, MFP 1 functions as a scanner. In this condition, MFP 1 is disabled to execute copy operation. At this time, in setting screen area 207 of touch panel 206, operation mode display for making various settings for scan operation is provided. After completion of various settings, by setting an original and pressing down start key 201, scan operation is started.

Copy key 210 and scan key 211 operate exclusively, and when one is selected, the other is automatically in an unselected state.

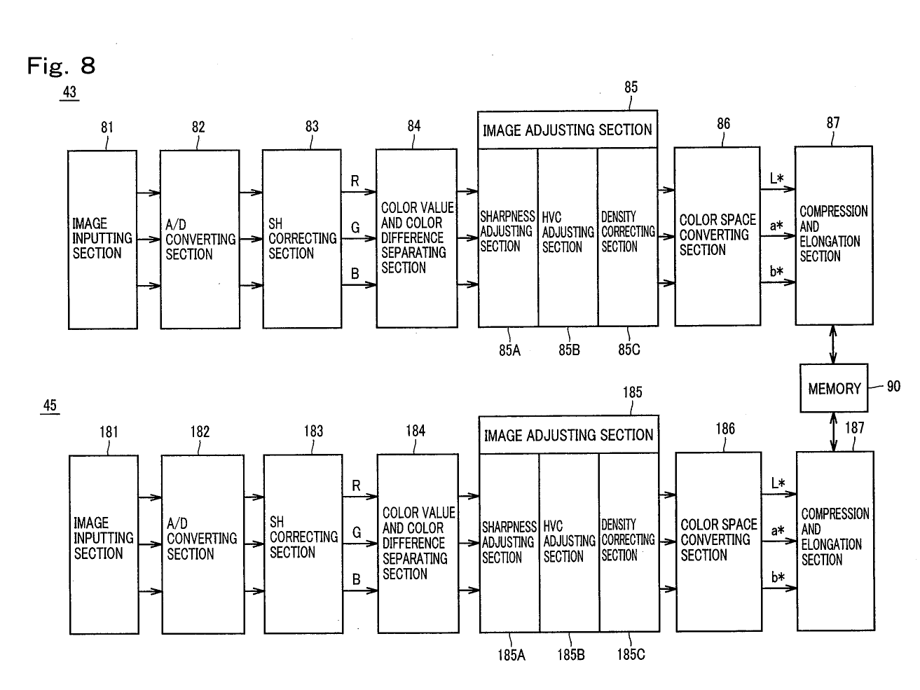

Outline of functions of first and second image processing sections will be described by using FIG. 8.

With reference to FIG. 8, first image processing section 43 includes an image inputting section 81, an A/D converting section 82, an SH correcting section 83, a color value and color difference separating section 84, an image adjusting section 85, a color space converting section 86, and a compressing/elongating section 87. Second image processing section 45 includes an image inputting section 181, an A/D converting section 182, an SH correcting section 183, a color value and color difference separating section 184, an image adjusting section 185, a color space converting section 186, and a compressing/elongating section 187. Since first image processing section 43 and second image processing section 45 have the same configuration, the following description will be made only for first image processing section 43.

Into image inputting section 81, image data of red (R), green (G) and blue (B) is inputted from first reading section 41. A/D converting section 82 converts analogue image data inputted from first reading section 41 into digital image data. SH correcting section 83 makes shading correction on image data inputted from A/D converting section 82, and outputs image data after shading correction to color value and color difference separating section 84. Color value and color difference separating section 84 separates image data into color value component and color difference component, and outputs them to image adjusting section 85. Image adjusting section 85 includes a sharpness adjusting section 85A, an HVC adjusting section 85B and a density correcting section 85C. Sharpness adjusting section 85A executes a process of sharpening an image, and HVC adjusting section 85B adjusts hue (H), color value (V) and chromaticness (C) of the image. Density correcting section 85C corrects density of image. Image adjusting section 85 outputs respective image data of RGB having processed, to color space converting section 86. Color space converting section 86 converts color space of image data from RGB color space to L*A*B* color space, and outputs to compressing/elongating section 87. Compressing/elongating section 87 compresses image data. Compressing/elongating section 87 stores compressed image data in memory 90 such as HDD (hard disc) or the like, or alternatively outputs to external device through external interface (I/F).

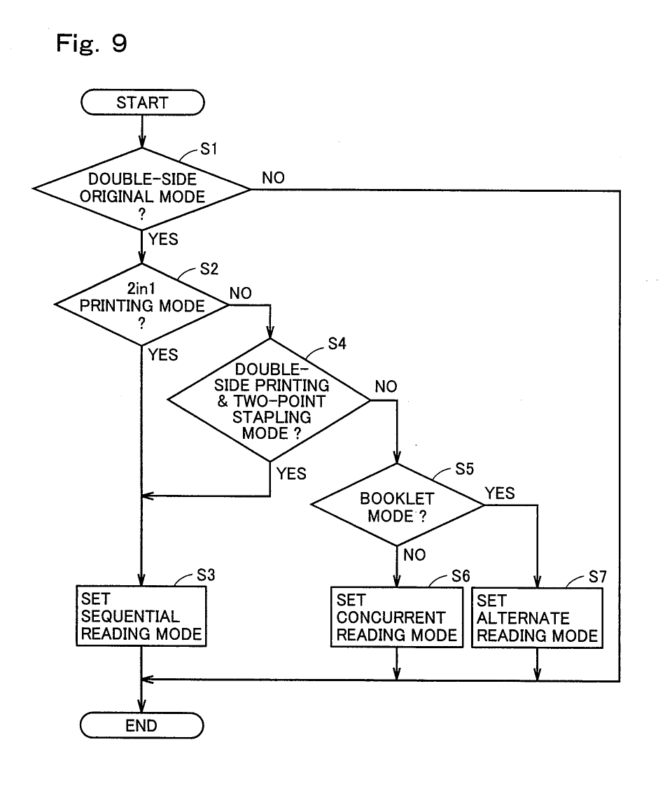

A control flow of determining reading the mode of the double-side original according to an embodiment of the present invention will be described by using FIG. 9.

With reference to FIG. 9, whether it is the double-side original mode is determined (Step S1). In other words, whether the read original is a double-side original is determined. This determination may be made based on whether double-side is selected and set as the form of the original, in the setting screen displayed when “one-side/double-side” setting button 234 is pressed down, as shown in FIG. 4.

And in Step S1, when it is the double-side original mode, that is, when reading of the double-side original is instructed, then whether the output form, i.e., printing form is two-in-one printing mode is determined (Step S2). This determination can be made based on whether two-in-one (2 in 1) is selected and set as combine setting in the setting screen displayed when “combine/original” setting button 222 is pressed down, as shown in FIG. 5.

In Step S2, when it is determined as two-in-one printing mode, the flow proceeds to Step S3, and sequential reading mode is set (Step S3). Sequential reading mode refers to the mode in which the front face and the back face of-the double-side original are read by using the same image sensor, e.g., a CCD sensor. Concretely, it is the mode in which conveyance path is switched according to switching of discharge/reversion switching sections 25, 26 as described above, the double-side original is reversed in ADF 3, and reading is executed using the same image sensor, e.g., CCD sensor.

In Step S1, when it is not a double-side original mode, usual reading method is executed as the one-side original mode. Concretely, reading may be achieved by using a CCD sensor. This determination may be made according to whether one-side is selected and set as a form of the original in the setting screen displayed when “one-side/double-side” setting button 234 is pressed down, as shown in FIG. 4. A state where one-side is selected as a form of the original may be set as a default.

In Step S2, when it is not two-in-one printing mode, whether it is double-side printing and two-point stapling mode is determined (Step S4). This determination may be made according to whether “two-point stapling” is selected and set as stapling process, in the setting screen displayed when “finishing” setting button 236 is pressed down, as shown in FIG. 7.

In Step S4, when it is double-side printing and two-point stapling mode, the flow proceeds to Step S3, and sequential reading mode is set.

On the other hand, when it is not double-side printing and two-point stapling mode in Step S4, whether it is booklet mode is determined (Step S5). This determination may be made according to whether “booklet” is selected and set in the setting screen displayed when “application” setting button 226 is pressed down, as shown in FIG. 6.

In Step S5, when it is a booklet mode, the flow proceeds to Step S7, and alternate reading mode is set (Step S7). On the other hand, when it is not a booklet mode, concurrent reading mode is set (Step S6).

Here, concurrent reading mode refers to the mode wherein the front face and the back face of the double-side original are concurrently read by using different image sensors, for example, by a CIS and a CCD sensor.

Here, alternate reading mode refers to the mode wherein concurrent reading the mode of the double-side original is executed, and concurrent reading is executed while front and back faces are reversed alternately for the odd-numbered originals and the even-numbered originals of the double-side originals as will be described later. Concretely, this is such a reading mode that when the front face and the back face of a certain double-side original are read by using a CCD sensor and a CIS, respectively, the next double-side original is reversed and back face and front face are read by a CCD sensor and a CIS, respectively.

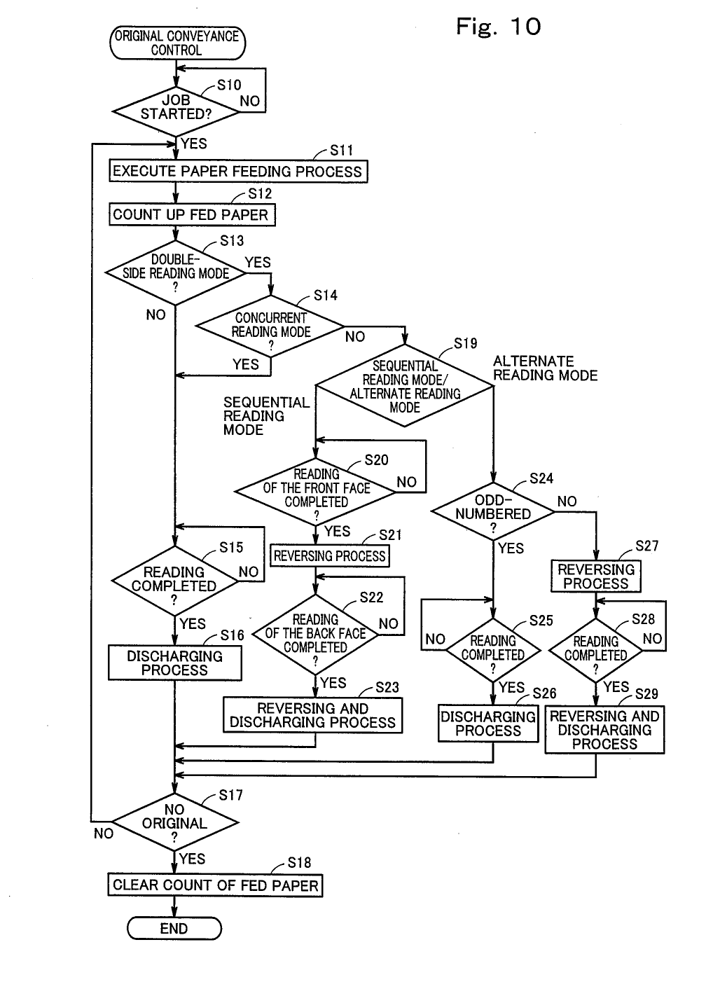

A flow of controlling conveyance of the original according to reading mode, according to an embodiment of the present invention will be described using FIG. 10.

With reference to FIG. 10, first, whether job (reading of the original) is started is determined (Step S10).

When it is determined that job is started, paper feeding process is executed (Step S11).

Next, counting up of fed paper is executed for counting the number of the fed originals (Step S12).

Next, whether it is double-side reading mode is determined (Step S13). In Step S13, when it is not double-side reading mode, namely, in a case of reading the one-side original, the flow proceeds to Step S15, and whether reading has completed is determined (Step S15).

In Step S15, when reading is completed, then discharging process is executed (Step S16).

Based on whether there is a next original for which the original to be read, the flow returns again to Step S11 when there is such an original. On the other hand, when there is not such an original, the flow proceeds to Step S18, and fed paper count is cleared for setting counting process of number of fed paper to an initial condition (Step S18). Then the flow ends. Whether there is a next original to be read is determined based on presence/absence of the original determined by using a sensor (not shown) provided on the paper feed side.

In Step S13, when it is double-side reading mode, then whether it is concurrent reading mode is determined (Step S14).

When it is concurrent reading mode, the flow proceeds to Step S15. Then in Step S15, when concurrent reading is completed, then discharging process is executed (Step S16). The subsequent process is similar to that described above, and hence detailed description thereof will not be repeated.

On the other hand, in Step S14, when it is not concurrent reading mode, the flow proceeds to step S19.

In Step S19, whether it is sequential reading mode or alternate reading mode is determined (Step S19).

In Step S19, when it is sequential reading mode, first, whether reading of the front face of the double-side original has completed is determined (Step S20). When reading of the front face of the double-side original is completed, then reversing process for reading the back face of the original in Step S21 is executed (Step S21).

Then whether reading of the back face of the double-side original has completed is determined (Step S22). In Step S22, when reading of the back face of the double-side original is completed, then reversing and discharging process is executed for recovering the initial state of the reversed original (Step S23).

Then the flow proceeds to Step S17.

When alternate reading mode is executed in Step S19, whether it is the odd-numbered original is determined in Step S24 (Step S24). When it is the odd-numbered original, whether reading of the double-side original has completed is determined (Step S25).

In Step S25, when reading is completed, then discharging process is executed (Step S26).

In Step S24, when it is not the odd-numbered original, namely it is the even-numbered original, the reversing process is executed in Step S27.

Then whether reading of the double-side original has completed is determined (Step S28).

In Step S28, when reading of the double-side original is completed, reversing and discharging process is executed for recovering initial state because the original is reversed in Step S27 (Step S29).

Now, the original reading process of the present invention will be described by way of a concrete example of the double-side original as described above.

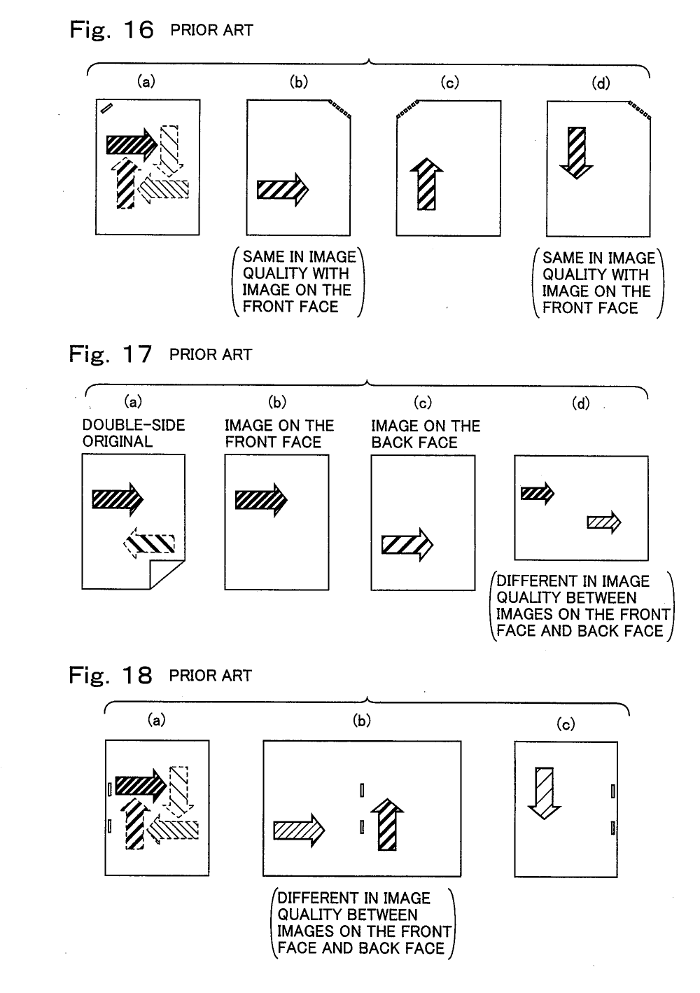

First, as shown in FIG. 16, a case where the double-side originals are double-side printed and one-point stapled is considered. Concretely, a case where two double-side originals as shown in FIG. 15 are double-side printed and one-point stapled will be described.

In this case, concurrent reading mode is set according to the control flow of FIG. 9.

Next, the original conveying process when the concurrent reading mode is set according to the control flow of FIG. 10 will be described.

With reference to FIG. 10, when job is started, the flow proceeds from Step S13(YES), Step S14(YES) to Step S15. Then whether reading has completed is determined in Step S15. When it is completed, discharging process is executed in Step S16.

Then, in the post processing step as described above, one-point stapling which is a stapling process is executed.

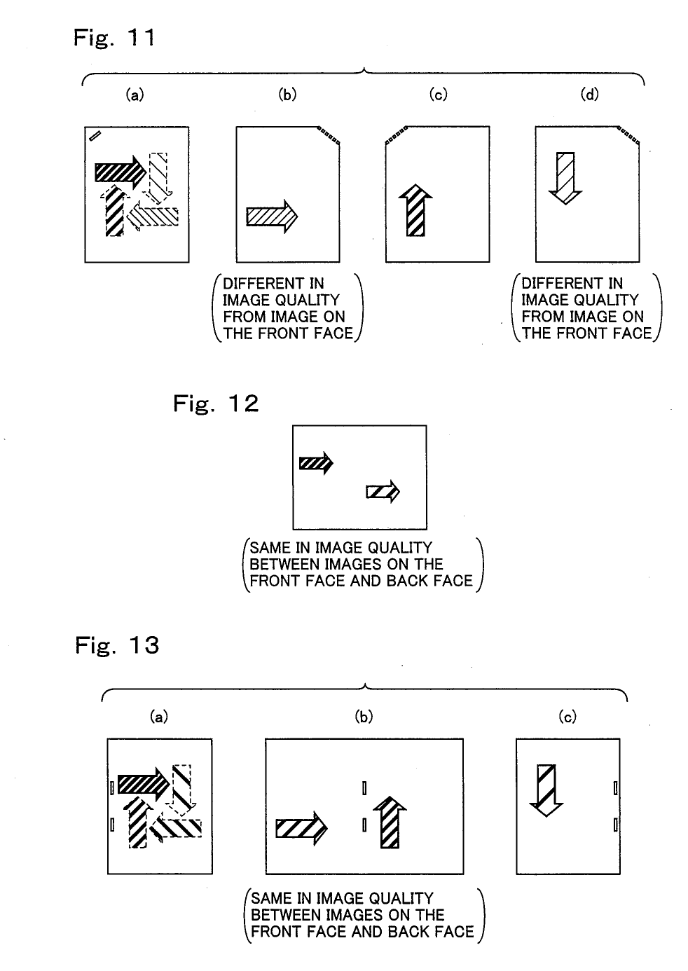

Using FIG. 11, description will be made for a case where the two double-side originals are concurrently read using different image sensors, double-side printed and then one-point stapled.

With reference to FIG. 11(a), here is shown a front face of double-side printed first printing sheet. Concretely, as one example, there is shown a case where reading of the front face of the first double-side original is executed using a CCD sensor, and the read graphic is printed on the front face of first printing sheet. Also shown is a graphic of left-pointing arrow bordered by dotted lines drawn on the back face, viewed from front face of the first sheet, and graphics of arrows bordered by dotted lines on the front face and back face of second sheet.

With reference to FIG. 11(b), here is shown a case where printing sheets having subjected to stapling process are bent at the left upper end, and reading of the back face of the first double-side original is executed using a CIS, and the read graphic is printed on the back face of first printing sheet.

With reference to FIG. 11(c), here is shown a case where printing sheets having subjected to stapling process are bent at the left upper end, and reading of the front face of the second double-side original is executed using a CCD sensor, and the read graphic is printed on the front face of second printing sheet.

With reference to FIG. 11(d), here is shown a case where printing sheets having subjected to stapling process are bent at the left upper end, and reading of the back face of the second double-side original is executed using a CIS, and the read graphic is printed on the back face of second printing sheet.

Therefore, there is difference in image quality between image on the front face and image on the back face of first printing sheet. Also there is difference in image quality between image on the front face and image on the back face of second printing sheet.

When stapling process is executed on a plurality of printing sheets, concretely, one-point stapling is executed, a user will view back face of first sheet, front face of second sheet and back face of second sheet while bending the sheets one by one. Therefore, the user will not view back face of first sheet and front face of second sheet at once. In other words, the user would not be conscious of difference in image quality even if there is difference in image quality in the double-side original.

Therefore, as shown in FIG. 16, when reading of the double-side original is executed sequentially by using the same image sensor, e.g., CCD sensor, and the double-side original is double-side printed and one-point stapled, the face of the original is reversed in the conveyance path of the ADF, and process efficiency is deteriorated because both faces are read by the same sensor. However, when the double-side original is double-side printed and one-point stapled as an output form as is the method according to the present embodiment, by selecting concurrent reading mode, it is possible to execute double-side printing and one-point stapling that does not give conscious difference in image quality at high speed, and to improve throughput of original reading.

Next, as shown in FIG. 17(d), a case of executing two-in-one (2 in 1) copying on the double-side original is considered. Concretely, description will be made for a case of executing two-in-one copy on the double-side original as described in FIGS. 17(a) to (c).

In this case, sequential reading mode is set according to the control flow of FIG. 9.

Next, according to the control flow of FIG. 10, the original conveying process when sequential reading mode is set will be described.

Referring to FIG. 10, when job is started, the flow proceeds from Step S13(YES), Step S14(NO) to Step S19. Then in Step S19, since sequential reading mode is set, whether reading of the front face of the double-side original has completed is determined in Step S20. When it is completed, reversing process is executed in Step S21, and whether reading of the back face of the double-side original has completed is determined in Step S22. Then in Step S23, the double-side original is reversed and discharged.

Using FIG. 12, a case where the double-side original is two-in-one (2 in 1) copied in sequential reading mode will be described.

Referring to FIG. 12, by the original conveying process in sequential reading mode, the front and back faces of the double-side original are read by the same image sensor. Concretely, the front face and the back face of the double-side original are read by using the same image sensor, e.g., CCD sensor, and two-in-one copied, so that image quality is also the same between two graphics of arrows.

Therefore, as shown in FIG. 17(d), when the double-side original is concurrently read by using different image sensors (CCD sensor and CIS), and two-in-one copied, a user will view image on the front face and image on the back face having difference in image quality arises at once, and will be conscious of difference in image quality. However, when the double-side original is two-in-one copied as an output form as is the method according to the present embodiment, no image quality difference arises by setting sequential reading mode and hence two-in-one copy can be executed without leading consciousness of difference in image quality.

Next, as shown in FIG. 18, a case where the double-side original is double-side printed and two-point stapled will be considered. Concretely, description will be made for a case where the two double-side originals described in FIG. 15 are double-side printed and two-point stapled.

In this case, sequential reading mode is set according to the control flow of FIG. 9.

Next, according to the control flow of FIG. 10, the original conveying process when the sequential reading mode is set will be described.

Referring to FIG. 10, when job is started, the flow proceeds from Step S13(YES), Step S14(NO) to Step S19. Then in Step S19, since sequential reading mode is set, whether reading of the front face has completed is determined in Step S20. When it is completed, reversing process is executed in Step S21, and whether reading of the back face of the double-side original has completed is determined in Step S22. Then in Step S23, the double-side original is subjected to reversing and discharging process.

Then in the post processing step as described above, two-point stapling which is a stapling process is executed.

Using FIG. 13, a case where the double-side originals are double-side printed in sequential reading mode and two-point stapled will be described.

By the original conveying process in sequential reading mode as described above, the front face and the back face of the double-side original can be read by using the same image sensor. Concretely, double-side printing is achieved by reading the front face and the back face of the double-side original using the same image sensor, e.g., CCD sensor.

With reference to FIG. 13(a), here is shown a front face of double-side printed first printing sheet. Concretely, as one example, shown is a case where reading of the front face of the first double-side original is executed using a CCD sensor, and the read graphic is printed on the front face of first printing sheet. Also shown are a graphic of left-pointing arrow bordered by dotted lines drawn on the back face, viewed from front face of first sheet, and graphics of arrows bordered by dotted lines on the front face and back face of second sheet.

With reference to FIG. 13(b), a case where left end of printing sheet having subjected to stapling process is bent will be described. Concretely, in the left part, there is shown a case where reading of the back face of the first double-side original is executed by using a CCD sensor, and the read graphic is printed on the back face of first printing sheet. In the right part, there is shown a case where reading of the front face of the second double-side original is executed using a CCD sensor, and the read graphic is printed on the front face of second printing sheet.

With reference to FIG. 13(c), here is shown a back face of double-side printed second printing sheet. Concretely, as one example, a case where reading of the back face of the second double-side original is executed using a CCD sensor, and the read graphic is printed on the back face of second printing sheet is shown.

Therefore, as is a case of FIG. 13(b), there arises no difference in image quality between image on the back face of the first double-side original on the left side and image on the front face of the second double-side original on the right side in a condition where stapling process is executed and left end is bent;

Therefore, as shown in FIG. 18, when the double-side original is concurrently read by using different image sensors (CCD sensor and CIS), and the double-side original is double-side printed and two-point stapled, a user will view image on the front face and image on the back face between which difference in image quality arises at once, and will be conscious of the difference in image quality. However, when the double-side original is double-side printed and two-point stapled as an output form as is the method according to the present embodiment, no difference in image quality arises by setting sequential reading mode and hence double-side printing and two-point stapling can be executed without leading consciousness of difference in image quality.

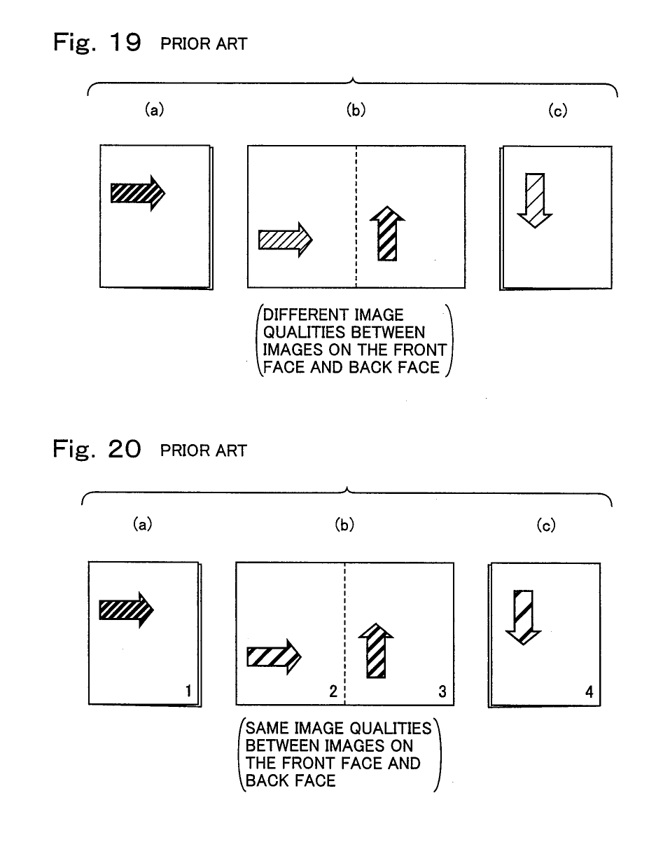

Next, as shown in FIG. 19 and FIG. 20, a case where the double-side original is booklet-copied is considered. Concretely, description will be made for a case where the two double-side originals shown in FIG. 15 are booklet-copied.

In this case, according to the control flow of FIG. 9, alternate reading mode is set.

Then, according to the control flow of FIG. 10, the original conveying process when sequential reading mode is set, will be described.

Referring to FIG. 10, when job is started, the flow proceeds from Step S13(YES), Step S14(NO) to Step S19. Then in Step S19, since alternate reading mode is set, the flow proceeds to Step S24. When it is the odd-numbered original, namely, the first original, the flow proceeds to Step S25 where concurrent reading is executed, and whether reading has completed is determined. Then discharging process is executed. Next, the flow proceeds to Step S17, and returns to Step S11 because there is a second original. The flow proceeds again to Step S24, and proceeds to Step S27 because the original is even-numbered. Then in Step S27, reversing process is conducted and concurrent reading is executed, and whether reading has completed is determined in Step 28. When it is determined in Step S28 that reading has completed, the original is reversed and discharged.

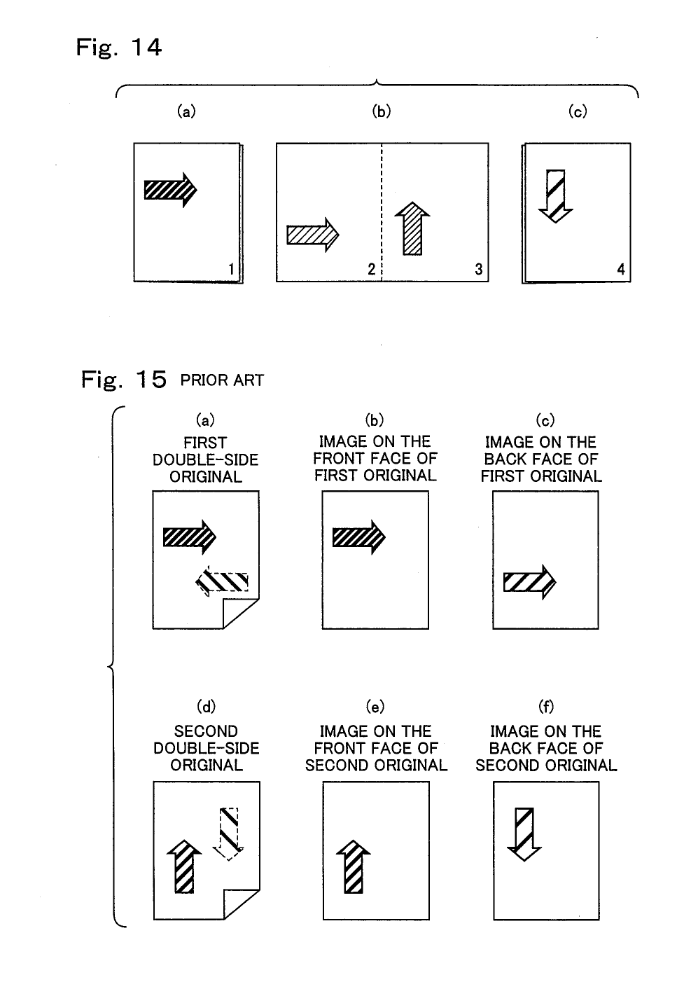

Using FIG. 14, a case where the double-side original is booklet-copied in alternate reading mode will be described.

In this case, image on the front face of the first (odd-numbered) original is read by using a CCD sensor, and image on the back face is read by using a CIS. Further, as for the second (even-numbered) original, image on the front face of is read by using a CIS, and image on the back face is read by using a CCD sensor.

With reference to FIG. 14(a), here is shown a case where the printing sheet is bent in the center part as described above, wherein as Page 1, the image on the front face of the first double-side original is read and printed on the right side of the front face of the printing sheet by the two-in-one copy as described above.

With reference to FIG. 14(b), here is shown a condition where the printing sheet is spread from a condition of FIG. 14(a), and as Page 2 and Page 3, the image on the back face of the first double-side original and the image on the front face of the second double-side original are read, and printed on the left side and the right side of the back face of the printing sheet by the aforementioned two-in-one copy.

With reference to FIG. 14(c), here is shown a condition where the printing sheet is bent in the center part from a condition of FIG. 14(b), and as Page 4, there is shown a case where the image on the back face of the second double-side original is read, and is printed on the left side of the front face of the printing sheet by two-in-one copy as described above.

Referring again to FIG. 14(b), in the present example, the left part shows a back face of the first double-side original read by a CIS and printed on the printing sheet, while the right part shows a front face of the second double-side original read by a CIS sensor and printed on the printing sheet, and no difference arises in image quality.

Therefore, as shown in FIG. 19, when the double-side original is concurrently read by using different image sensors (CCD sensor and CIS), and the double-side original is double-side printed and booklet-copied, a user will view image on the front face and the image on the back face between which difference in image quality arises at once, and will be conscious of the difference in image quality. However, when the double-side original is booklet-copied as an output form as is the method according to the present embodiment, no difference arises in image quality by setting alternate reading mode and hence booklet-copying can be executed without leading consciousness of difference in image quality.

Further, this example is the method in which the even-numbered original is reversed and concurrently read, while the odd-numbered original is concurrently read without being reversed.

Therefore, as shown in FIG. 20, when the double-side original is sequentially read and booklet copy is executed, the face of the original is reversed in the conveyance path of ADF, and images on the front and back faces of the original are read by one of image sensors, for example, only by a CCD sensor, and both faces are read by the same sensor. Therefore, processing efficiency is deteriorated. However, when the double-side original is booklet-copied as an output form as is the method according to the present embodiment, by setting alternate reading mode, it is possible to read the original with high processing efficiency of reading, while taking image quality of read original into account because concurrent reading is executed on the odd-numbered originals.

The above description is mainly made for two-in-one printing method, however, the same applies equally to n-in-one method without particularly limited to two-in-one method, namely, the method of printing n originals into one printing sheet.

Further, in the flow of FIG. 5, in Step S24 and Step S27, the method of executing reversing process in processing the even-numbered original is described, however, the method in which reversing process is executed in processing the odd-numbered original is also possible. In this case, modification may be made so that when the original is even-numbered in Step S24, the flow proceeds to Step S25, whereas when the original is odd-numbered one, the flow proceeds to Step S27.

Although the foregoing description is made only for a case of two-point stapling, stapling at more positions, such as three-point stapling may also be processed in a similar manner as for two-point stapling.

The image forming apparatus according to the present invention is not limited to MFP, and may be a printer or a facsimile device as far as it is an image forming apparatus. A program for making a computer to execute the control as described by the flow may be provided in place of the ADF controlling section and the scanner processing section for controlling the double-side image reading device. Such a program may be recorded in a readable recording medium such as flexible disc, CD-ROM (Compact Disk-Read Only Memory), ROM (Read Only Memory), RAM (Random Access Memory) and memory card in association with a computer, and may be provided as a program product. Alternatively, the program may be provided while it is recorded on a recording medium such as hard disc incorporated in a computer. Further, the program may be provided by downloading over networks.

The program according to the present invention may be the one that invokes a necessary module of program modules provided as a part of operation system (OS) of computer, in a predetermined sequence and in a predetermined timing, and makes the module to execute processing. In such a case, the above module is not contained in the program itself, and processing is executed in corporation with OS. Such a program that does not contain a module may also be included in the program of the present invention.

The program according to the present invention may be provided while it is incorporated as a part of other program. Also in such a case, the program itself does not contain a module contained in the above other program, and processing is executed in corporation with the other program. Such a program that is incorporated in other program may also be included in the program of the present invention.

A provided program product is installed to a program storing section of hard disc or the like; and executed. Such a program product includes a program itself and a recording medium on which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A double-side image reading device comprising:
a conveying section that includes a conveyance path for conveying a fed original;
a first reading section that reads an image on one face of the original from one side of the conveyance path;
a second reading section that reads an image on one face of the original from an opposite side to said first reading section with the conveyance path interposed therebetween; and
a reading controlling section that controls said conveying section, said first and second reading sections for executing reading of a double-side original, wherein
said reading controlling section responds to a setting designation of an output form for outputting the image of the double-side original to execute reading of the double-side original in one of a first and second double-side reading modes, said first double-side reading mode which allows reading of images on front and back faces of the double-side original by reading an image on one face of the double-side original using only one of said first and second reading sections and then reading an image on another face by using only one of said first and second reading sections by reversing and conveying the original, and said second double-side reading mode which allows reading of the images on the front and back faces of the double-side original using said first and second reading sections during a single conveyance.

2. The double-side image reading device according to claim 1, wherein said reading controlling section designates execution of reading of the double-side original in said first double-side reading mode when the setting instruction of the output form for outputting the images on said double-side original is a mode for outputting the images on the front and back faces of at least one double-side original onto one face, and designates execution of reading of the double-side original in said second double-side reading mode in other cases.

3. The double-side image reading device according to claim 1, wherein said reading controlling section designates execution of reading of the double-side original in said first double-side reading mode when said setting designation of the output form for outputting images on the double-side original is a mode for outputting the images on front and back faces of a plurality of double-side originals onto front and back faces of a plurality of printing sheets respectively and executing a stapling process in a plurality of points is designated, while said reading controlling section designates execution of reading of the double-side original in said second double-side reading mode in other cases.

4. The double-side image reading device according to claim 1, wherein said reading controlling section designates execution of reading of the double-side original in said second double-side reading mode when said setting designation of the output form for outputting the images on the double-side original is a mode for outputting images on front and back faces of a plurality of double-side originals onto front and back faces of a plurality of printing sheets respectively and printing a booklet in which one printing sheet includes a plurality of pages is designated, while said reading controlling section designates execution of reading of images on front and back faces of a next double-side original in a reversed condition, compared to a case of reading images on front and back faces of a previous double-side original, in reading the images on the front and back faces of the plurality of double-side originals.

5. An image forming apparatus comprising a double-side image reading device, the double-side image reading device including:
a conveying section that includes a conveyance path for conveying a fed original;
a first reading section that reads an image on one face of the original from one side of the conveyance path;
a second reading section that reads an image on one face of the original from an opposite side to said first reading section with the conveyance path interposed therebetween; and
a reading controlling section that controls said conveying section, said first and second reading sections for executing reading of a double-side original, wherein
said reading controlling section responds to a setting designation of an output form for outputting an image of the double-side original to execute reading of the double-side original in one of a first and second double-side reading modes, said first double-side reading mode which allows reading of images on front and back faces of the double-side original by reading an image on one face of the double-side original using only one of said first and second reading sections and then reading an image on another face by using only one of said first and second reading sections by reversing and conveying the original, and said second double-side reading mode which allows reading of images on the front face and back face of the double-side original using said first and second reading sections during a single conveyance, and
the apparatus further comprising:
an output form setting section for setting the output form for outputting images on the double-side original; and
an image forming section that forms an image read by said double-side image reading device.

6. The image forming apparatus according to claim 5, further comprising a staple processing section that executes a stapling process in response to a designation on a plurality of printing sheets printed in said image forming section.
